(19) United States
(12) Patent Application Publication
(10) Pub. No.: US 2014/0303987 A1
(43) Pub. Date: Oct. 9, 2014

(54) PREDICTION OF AN OPTIMAL MEDICAL TREATMENT

(71) Applicant: International Business Machines Corporation, Armonk, NY (US)

(72) Inventors: Jen-Hao Hsiao, Taipei (TW); Xinxin Zhu, Croton-on-Hudson, NY (US)

(73) Assignee: International Business Machines Corporation, Armonk, NY (US)

(21) Appl. No.: 13/971,052

(22) Filed: Aug. 20, 2013

Related U.S. Application Data
(63) Continuation of application No. 13/858,218, filed on Apr. 8, 2013.

(51) Int. Cl. G06F 19/00

(52) U.S. Cl. CPC G06F 19/345; G06F 19/3443
USPC 705/2

(57) ABSTRACT

A method of determining an optimal treatment includes determining a frequency for each health care provider indicating how frequently each treats a selected disease, determining for each health care provider, their average patient outcome APO for treating the selected disease, determining a score for each health care provider based on the corresponding frequency and APO, determining which of the health care providers are experts from the scores that exceed a predefined threshold, and selecting a treatment proscribed by at least one of the identified experts as the optimal treatment.

### CROSS-REFERENCE TO RELATED APPLICATION

Thus application is a continuation of application Ser. No. 13/858,218, filed on Apr. 8, 2013, the disclosure of which is incorporated by reference in its entirety.

### BACKGROUND

1. Technical Field

The present disclosure relates to the field of medical treatment, and more particularly to the prediction of an optimal medical treatment based on expert knowledge.

2. Discussion of Related Art

A physician often has to independently make decisions for the medical therapy or treatment of a patient as a result of a medical consultation. However, since the experience of each physician varies considerably, the chosen treatment may not be optimal. For example, young physicians often have very limited practical experience in recognizing various kinds of diseases and determining the optimal corresponding treatment. While older more experienced physicians have this experience and are more likely to prescribe the optimal treatment, there is no way to transfer this experience to the younger less experienced physicians.

Accordingly, there is a need for methods and systems that can predict an optimal medical treatment based on expert knowledge.

### BRIEF SUMMARY

According to an exemplary embodiment of the invention, a method of determining an optimal treatment includes: determining a frequency for each health care provider indicating how frequently each treats a selected disease, determining for each health care provider, their average patient outcome APO for treating the selected disease, determining a score for each health care provider based on the corresponding frequency and APO, determining which of the health care providers are experts from the scores that exceed a predefined threshold, and selecting a treatment proscribed by one of the identified experts as the optimal treatment.

According to an exemplary embodiment of the invention, a method of determining an optimal treatment includes: determining a score for each health care provider based on their level of expertise in treating a selected disease, determining which of the health care providers are experts from the scores that exceed a predefined health provider score, ranking treatments provided by the experts for the disease based on how often the treatment is found with the disease in medical records, and selecting one of the treatments with a ranking exceeding a predefined treatment ranking as the optimal treatment.

### BRIEF DESCRIPTION OF THE SEVERAL VIEWS OF THE DRAWINGS

Exemplary embodiments of the invention can be understood in more detail from the following descriptions taken in conjunction with the accompanying drawings in which:

FIG. 1 illustrates a high level flow chart for a method to provide an optimal medical treatment in accordance with an exemplary embodiment of the present invention.

FIG. 2 illustrates a system that operates in accordance with an exemplary embodiment of the present invention.

FIG. 3 illustrates a method of determining experts for treating a particular disease in accordance with an exemplary embodiment of the present invention.

FIG. 4 illustrates an exemplary user interface used to query for the optimal treatment in accordance with an exemplary embodiment of the present invention.

FIG. 5 illustrates an example of a computer system capable of implementing methods and systems according to embodiments of the disclosure.

### DETAILED DESCRIPTION

Embodiments of the present invention relates to methods and/or systems that may be used to provide an optimal medical treatment.

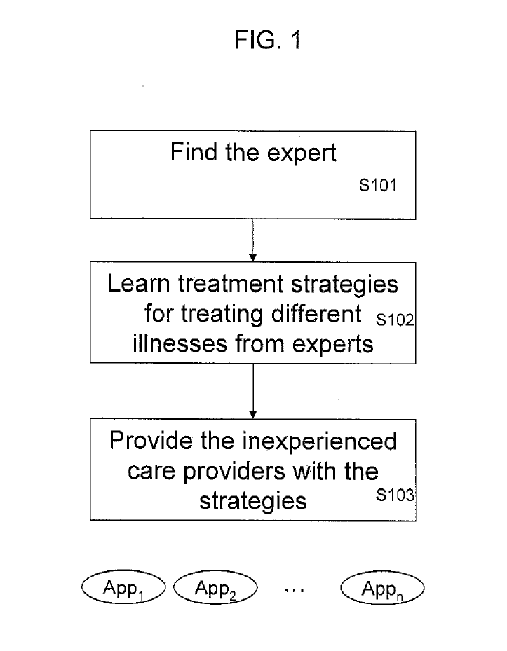

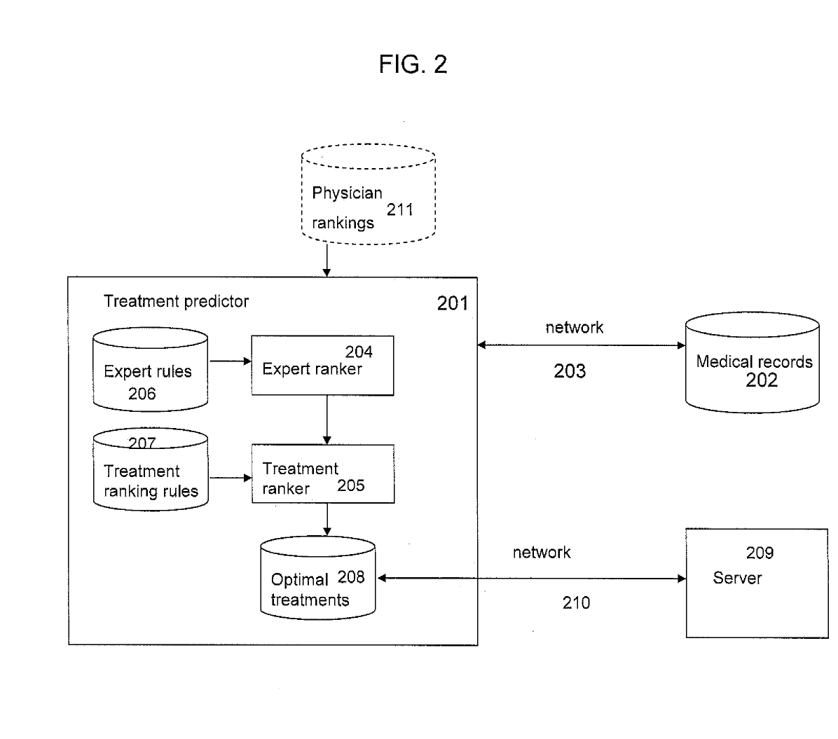

FIG. 1 illustrates a method to provide an optimal medical treatment in accordance with an exemplary embodiment of the present invention. Referring to FIG. 1, the method includes determining who the experts are (S101), learning the treatment strategies for treating different illnesses from the determined experts (S102), and providing the learned strategies to inexperienced care provides with the learned treatment strategies (S103). The determination of the experts and the learning of the treatment strategies are described in more detail below with respect to FIG. 2. The applications App₁, App₂, Appₙ are applications that can be created using the learned treatment strategies.

Referring to FIG. 2, there is illustrated a system that includes a treatment predictor 201 that predicts optimal medical treatments based on existing medical records 202. The medical records may be retrieved remotely across a network 203 or through a local connection. The network 203 may be a public or a private network. If a public network such as the Internet is used, the medical records 202 may need to be encrypted to protect them from unauthorized access. The treatment predictor 201 may be embodied as software on a computer system.

The treatment predictor 201 includes an expert ranker 204 and a treatment ranker 205. While FIG. 2 illustrates the expert ranker 204 and a treatment ranker 205 as separate units, this is merely for ease of discussion as a single unit may perform the functions of each unit.

The expert ranker 204 is used to determine which physicians have the richest experience regarding a specific disease (i.e., the experts). The expert ranker 204 analyzes the medical records 202 to determine the available physicians and which diseases they have been treating. For example, the medical records 202 of each patient may indicate the identity of the treating physician, the period in which they treated the patient, the disease the patient has been diagnosed with, the treatment applied for that disease, and the outcome of the treatment, etc.

A given treatment may include one or more procedures, medicines (e.g., including dosage), interventions, therapies (e.g., rehabilitation, chemotherapy, etc.), and diagnostic or laboratory tests ordered by the physician during a given period for the patient and the sequence they were applied. For example, even though treatment A and treatment B both treat a patient with medicine 1 and medicine 2, the patients may have different outcomes based on the order in which these medicines were administered. Each identified treatment may be assigned a unique treatment identifier so that they can be distinguished from one another.

The outcome of a treatment is either located directly in the medical record (e.g., “patient condition improved”, “patient condition worsened”, etc.) or can be inferred based on predefined rules. For example, if the patient has diabetes and their blood glucose after being treated with insulin is improved, it can be inferred that the treatment of insulin had a positive outcome for the disease of diabetes. The treatment predictor 201 may include or have access to a rule for each disease that indicates one or more thresholds that can be compared against diagnostic data in the medical records 202 to infer whether the treatment achieved a positive result, a negative result, or a neutral result. The outcome may also have several levels of granularity. For example, a reduction in blood glucose level to a first range could indicate a good outcome while a further reduction could indicate a very good outcome.

The expert ranker 204 can sift through the medical records 202 to determine the physicians who are frequently involved in a related medical consultation (e.g., for a particular disease) with positive outcomes. The expert ranker 204 can generate a physician score for each physician based on one or more factors. In an exemplary embodiment of the invention, the physician score for a physician treating a disease is calculated using Equation 1 as follows:

$$P {Score}_{1} ( {P}_{i} , {D}_{j} ) = {w}_{0} \times Freq ( {P}_{i} , Dj ) + {w}_{1} \times \frac{Freq ( {P}_{i} , {D}_{j} )}{\sum Freq ( {P}_{i} , {D}_{j} )} + {w}_{2} \times APO ( {P}_{i} , {D}_{j} ) \qquad [ 1 ]$$

In Equation 1, Pᵢ represents the i-th physician, Dⱼ represents the j-th disease, w₀, w₁, and w₂ are arbitrary weights, APO is the average patient outcome of a particular physician for a given disease (i.e., the j-th disease), where i and j are integers that are one or greater.

The first term of Equation 1 indicates the frequency of the i-th physician involved in the treatment of the j-th disease (e.g., relative to other physicians). For example, if during a given period of time (e.g., within the last year), physician A entered an ICD code for diabetes (e.g., 250.xx) 500 times into the medical records 202 and physician B entered the same ICD code 1000 times, the frequency of physician B for treating diabetes would be twice that of physician A.

The second term of Equation 1 indicates whether the physician specializes in the particular disease (i.e., is it their primary care domain). The second term indicates the percentage of the j-th disease in the total number of diseases being diagnosed by the i-th physician. For example, if two physicians each enter 2000 codes within the last year, and 1500 of them for physician A were for diabetes, while only 500 of them for physician B were for diabetes, the second term would correspond to 75% for physician A for treating diabetes and 25% for physician B for treating diabetes. Thus, it is more likely that physician A has more experience treating diabetes than physician B.

The third term of Equation 1 (e.g., APO) refers to the average patient outcome of patients having the j-th disease who are treated by the i-th physican for that disease. For example the value could be the average hba1c (i.e., a lab value that shows average level of blood sugar over a previous 3 month period) improvement of all patients treated by the i-th physician for diabetes. For example, if the average blood sugar levels of patients treated for diabetes by physician A improved by 10% and the average blood sugar levels of patients treated by physician B improved by 30%, the APO value for physician B would be higher than that of physician A (e.g., 3:1 better).

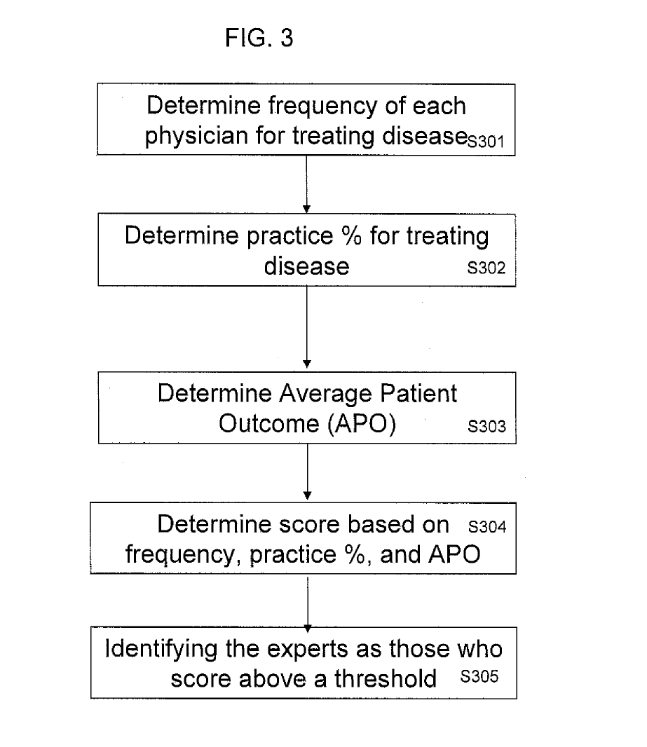

Thus, referring to FIG. 3, the method of determining the experts includes: determining the frequency of each physician for treating the disease (S301), determining how much of their practice goes into treating the disease (e.g., practice percentage or ratio) (S302), determining the average patient outcome (APO) of patients with the disease that have been treated by the physician (S303), generating a physician score based on the frequency, practice percentage, and APO (S304), and identifying the experts as those who score above a predefined threshold score (S305). Steps S301-S303 of FIG. 3 may be performed in any order. For example, the frequency is relative to other doctors and the practice percentage or ratio is relative to other diseases treated by the same physician.

The resulting physician scores can then be ordered from lowest to highest or highest to lowest to determine the highest ranking physicians for treating a particular disease. For example, if several physicians were ranked for treating diabetes, the highest ranking score can be selected as the expert or several experts can be selected from the scores that are above a predefined threshold score.

In an alternate embodiment, the physician score is derived by adding an additional physical ranking term to Equation 1, which is extracted from a physician rankings database 211. The physician rankings 211 may be come from a third-party source (e.g., Healthgrades.com). The physician ranking can be an overall ranking of the physician or a specific ranking of the physician for treating a particular disease or for a particular healthcare domain. A weight may be multiplied by the fourth term, like the weights w₀-w₂ described above for the first three terms so the physician score can be adjusted as necessary.

In another alternate embodiment, the second term of Equation 1 is omitted and the patient score is calculated according to Equation 2 as follows:

PScore₂(Pᵢ,Dⱼ)=w₀xFreq(Pᵢ,dj)+w₂xAPO(Pᵢ,Dⱼ) [2]

Equation 2 may be modified to include the above-described fourth term, which corresponds to the third-party physician ranking.

The identities of the selected experts are output by the expert ranker 204 to the treatment ranker 205. For example, assume of 100 physicians scored, 10 have been ranked as experts in the field of treating diabetes. The treatment ranker 205 analyzes the treatments used by each of these experts for treating the same disease to determine the most effective ones. The treatment ranker 205 generates a treatment score for each of these treatments. If a treatment has a higher treatment score, it will be considered more effective at treating the corresponding disease.

However, when examining the medical records 202, it may not be immediately clear which treatment applied by the expert physician resulted in the positive outcome. The treatment ranker 205 identifies the treatments applied by the identified experts and generates a treatment score according to Equation 3 as follows:

$$T Score ( {D}_{j} , {T}_{k} ) = \frac{P ( {D}_{j} ⋂ {T}_{k} )}{P ( {D}_{j} )} + log \frac{1}{P ( {T}_{k} )} \qquad [ 4 ]$$

In Equation 4, Dⱼ represents the j-th disease and Tₖ represents the k-th treatment.

The first term of Equation 4 indicates how well each treatment correlates with a particular disease. For example, assume there have been 1000 treatments (e.g., T₁-T₁₀₀) by the experts which reference diabetes and of these, treatment T₁ occurred 50 times while treatment T₁₀₀ occurred 40 times. Thus, the first term for treatment T₁ would be higher than the first term for treatment T₁₀₀.

The second term of Equation 4 is used to remove noise. For example, some treatments are used in conjunction with many diseases, but have no effect on the outcome. For example, many different diseases may be treated with pain medicines even though they ultimately are not responsible for the positive outcome. For example, a patient suffering from ulcers caused by diabetes may receive a first treatment of pain medicine to relieve the pain and a second treatment of insulin to lower their blood sugar level. However, of these two treatments, it is the second treatment that was actually responsible for the patient's positive outcomes. The second term can be used to adjust the treatment score to filter out the treatments that did not contribute to the positive outcome. For example, if a treatment is found to be co-located with many different diseases, especially from different healthcare domains, it may be an indication that it did not contribute to the positive outcome.

The method of generating the treatment score may be stored as a rule in the treatment ranking rules database 207. The treatment ranker 205 can then sort the treatment scores for each disease and store the most optimal treatments (e.g., the ones with a treatment score exceeding a predefined threshold) in the optimal treatments database 208. The database 208 can be a relational database that stores at least one optimal treatment for each disease in a table that can be locally accessed or remotely accessed by a user on a server 209 across network 210.

In an exemplary embodiment, the treatment predictor 201 stores query software and the server 209 stores a client program (e.g., a graphical user interface GUI) that communicates with the query software. The client program enables a user to enter a particular disease to retrieve a list of the most optimal corresponding treatments from the treatment database 208. The list can be used as a means to prevent medical errors. For example, if a physician proscribes a treatment for a disease, the list generated based on the entered disease should include the proscribed treatment. Thus, a medical worker can quickly confirm whether the proscribed treatment is the correct or optimal treatment. Further, instead of entering the disease into the user interface, the user can enter the proscribed treatment. The query software then searches the database 208 to determine what disease experts typically apply the entered treatment to. Thus, a user can quickly determine whether the physician has erroneously ordered a treatment for a disease that is not listed in the patient's chart.

For example, the server 209 is configured to send a computer message to the treatment predictor 201, which includes either the particular treatment, disease, illness, symptom, etc.

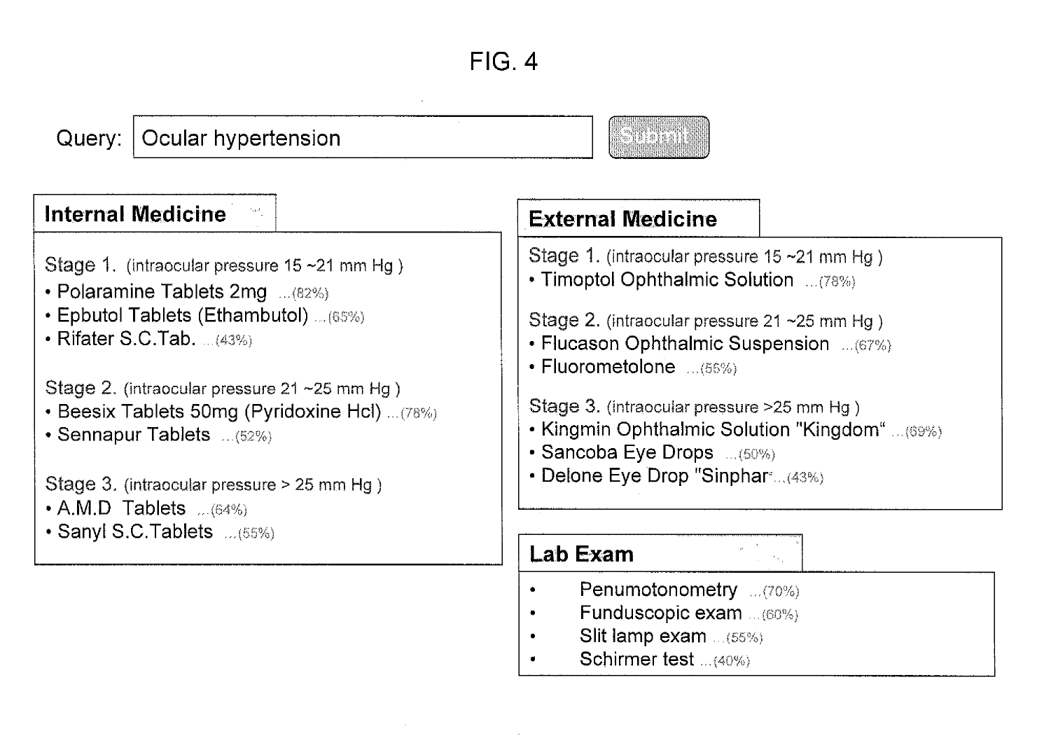

FIG. 4 illustrates an example of the client interface. In this example, the medical disease entered was ocular hypertension. In response to hitting the submit button, the query software returned the most common treatment steps performed by the identified experts for treating ocular hypertension. With respect to the internal medicine treatments for ocular hypertension, 82% of the identified experts proscribed Polarmine tablets as their first treatment step, and 78% of the identified experts proscribed Beesix tablets. With respect to the external medicine treatments for ocular hypertension, 78% of the identified experts proscribed Timoptol tablets as their first treatment step, and 67% of the identified experts proscribed a Flucason Opthalmic Suspension as their second treatment. With respect to the ordered laboratory tests, 70% of the identified experts ordered a Penumtonometry test and 60% of experts ordered a Funuscopic exam.

However, the inventive concept is not limited to the client interface and results illustrated in FIG. 4 as it merely refers to one possible application for the learned treatment strategy. For example, a treatment instead of a disease or symptom could be entered in the query field to return a list of the corresponding most commonly treated diseases.

At least one embodiment of the invention enables knowledge and insights learned from senior physicians to be used in various applications. For example, an expert knowledge database can be created, which can lead younger, less experienced care providers to the strategies that could improve care. Further, at least embodiment of the invention can be integrated with an existing hospital information system (HIS) to provide treatment suggestions. Further, an embodiment of the invention may be integrated with the HIS as background checking component for prevention of medical errors.

Please note while the above disclosure has referred to diabetes and ocular hypertension as the diseases being treated, the invention is not limited thereto and may be applied to various other diseases or conditions.

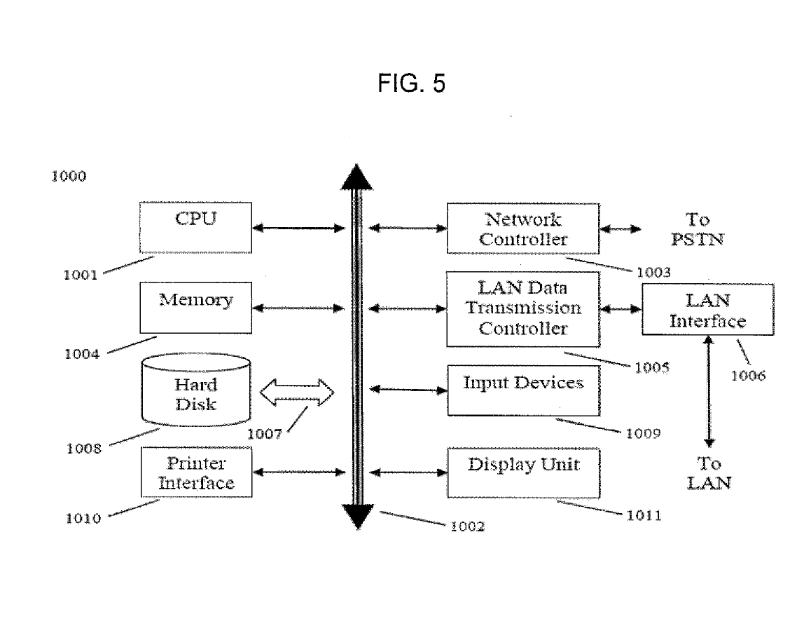

FIG. 5 illustrates an example of the above-described computer system, which may execute any of the above-described methods, according to exemplary embodiments of the invention. For example, the method of FIG. 3 may be implemented in the form of a software application running on the computer system. Further, portions of the methods may be executed on one such computer system, while the other portions are executed on one or more other such computer systems. Examples of the computer system include a mainframe, personal computer (PC), a handheld computer, a server, etc. The software application may be stored on a computer readable media (such as hard disk drive memory 1008) locally accessible by the computer system and accessible via a hard wired or wireless connection to a satellite or a network, for example, a local area network, or the Internet, etc.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk 1008 (e.g., a digital video recorder), via a link 1007. CPU 1001 may be the computer processor that performs the above described methods.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer program product for determining an optimal treatment, the computer program product comprising a computer readable storage medium having program code embodied therewith, the program code executable by a processor, to perform method steps comprising:
determining a frequency for each health care provider indicating how frequently each treats a selected disease;
determining for each health care provider, their average patient outcome APO for treating the selected disease;
determining a score for each health care provider based on the corresponding frequency and APO;
determining which of the health care providers are expert from the scores that exceed a predefined threshold; and
selecting a treatment proscribed by at least one of the identified experts as the optimal treatment.

2. The computer program product of claim 1, wherein the determining of the score further comprises:
determining for each health care provider, among treatments applied by the corresponding healthcare provider, a percentage of these treatments used to treat the selected disease; and
determining a score for each health care provider based on the corresponding frequency, percentage, and APO;

3. The computer program product of claim 2, wherein the frequency, percentage, and average patient outcome are identified based on treatments proscribed for the disease in medical records during a same given period.

4. The computer program product of claim 2, wherein the score is a sum of a first term comprising the frequency, a second term comprising the percentage, and a third term comprising the APO.

5. The computer program product of claim 4, wherein a weight is multiplied by each term.

6. The computer program product of claim 1, wherein selecting the treatment comprises:
ranking treatments provided by each identified expert for the disease; and
selecting the ranked treatment with the highest rank.

7. The computer program product of claim 6, wherein the ranking comprises reducing the ranking of a corresponding treatment based on how often it is associated with medical fields outside a medical field of the selected disease.

8. The computer program product of claim 1, wherein the APO is a first value when it indicates an average patient improvement from the selected treatment and a second value when it indicates an average patient worsening from the treatment result, and the first value is higher than the second value.

9. The computer program product of claim 2, wherein the frequency is a number of medical codes entered by the health care provider during the given period that indicate the selected disease.

10. The computer program product of claim 9, wherein the percentage is the frequency divided by a total number of the medical codes entered by all health care providers for the selected disease during the given period.

11. A computer program product for determining an optimal treatment, the computer program product comprising a computer readable storage medium having program code embodied therewith, the program code executable by a processor, to perform method steps comprising:
determining a score for each health care provider based on their level of expertise in treating a selected disease;
determining which of the health care providers are experts from the scores that exceed a predefined health provider score;
ranking treatments provided by the experts for the disease based on how often the treatment is found with the disease in medical records; and
selecting one of the treatments with a ranking exceeding a predefined treatment ranking as the optimal treatment.

12. The computer program product of claim 11, wherein the score is based on how frequently the healthcare provider treats the selected disease relative to other healthcare providers, an average patient outcome that results from the healthcare provider treating the selected disease, and a percentage of the health care provider's practice that treats the selected disease.
